(19) United States
(12) Patent Application Publication
(10) Pub. No.: US 2026/0235832 A1
(43) Pub. Date: Aug. 13, 2026

(54) CO-PACKAGED PHOTONIC INTEGRATED CIRCUIT (IC) ASSEMBLY AND METHOD FOR FABRICATING THE SAME

(71) Applicant: XILINX, INC., San Jose, CA (US)

(72) Inventors: Fang-Yu LIANG, Hsinchu City (TW); Suresh RAMALINGAM, Fremont, CA (US); Hao-Hsiang LIAO, Freemont, CA (US)

(21) Appl. No.: 19/387,471

(22) Filed: Nov. 12, 2025

Related U.S. Application Data
(60) Provisional application No. 63/755,942, filed on Feb. 7, 2025.

(51) Int. Cl. G02B 6/43; G02B 6/42

(52) U.S. Cl. CPC G02B 6/43; G02B 6/4206; G02B 6/4231; G02B 6/4239; G02B 6/4244; G02B 6/4245; G02B 6/4272

(57) ABSTRACT

A photonics integrated circuit (PIC) assembly and method for fabricating the same are provided. In one example, the method includes aligning a first wafer comprising a plurality of photonics ICs with a second wafer comprising a plurality of optical couplers; bonding the first wafer to the second wafer such that each optical coupler of the plurality of optical couplers is aligned with a corresponding photonics IC of the plurality of photonics ICs; and singulating the photonics ICs, each singulated photonics IC bonded to one of the plurality of optical couplers to form an photonics IC assembly. In another example, a PIC assembly is provided that includes a photonics IC bonded an optical coupler. The photonics IC and the optical coupler having sidewalls aligned to form outer lateral sidewalls (boundaries) of the photonics IC assembly.

### CROSS REFERENCE TO RELATED APPLICATIONS

This application claims benefit of United States Provisional Patent Application No. 63/755,942, filed February 07, 2025, which is incorporated by reference in its entirety.

### BACKGROUND

As bandwidth keeps increasing, co-package optics (CPO) is becoming a trend for artificial intelligence (AI) and high-performance computing (HPC) seeking to enhance data transferring rates and save power. In CPO, optical engine (OE), ASIC, GPU, chiplet and the like, are placed on the same organic substrate as a photonics IC (PIC), which shortens interconnection route, helps to mitigate the degradation of high-frequency signal and saves overall power consumption.

However, as more OEs associated with chip packages, more challenging manufacturing becomes. Significant effort has been spent investigating variety of couplers and running many test vehicles for proof-of-concept. But from assembly process and cost point of view, units per hour (UPH) manufacturing rate for currently proposed designs is extremely low. As a result, no currently proposed design is practical for mass production. One reason for the low UPH is that coupler (no matter the design), needs to be placed on the PIC precisely (<0.5 um accuracy), and current equipment can only pick up and place one coupler at a time. Then, equipment’s bond head needs to hold the coupler for UV exposure (up to 30 seconds). Even if equipment vendor optimizes the bond head design to enable multiple bond heads in one machine, the UPH is still low due to the waiting time required for UV exposure.

Thus, there is a need for a new technique for connecting a coupler to a PIC.

### SUMMARY

Disclosed is a novel optical coupler placement technique that not only enhances throughput but sustains high accuracy. An “optical coupler wafer” is first manufactured, followed by bonding the “optical coupler wafer to photonics wafer”. The bonding process accurately pairs an optical coupler with a PIC die. Once bonded, the optical coupler/photonics wafer stack is singulated to separate PIC assemblies, where the sidewalls of the couple and the PIC die are vertically aligned to form a common sidewall of the PIC assembly.

In one example, a photonics integrated circuit (IC) assembly is provided that includes a photonics IC die and an optical coupler. The optical coupler is bonded to the photonics IC die. The photonics IC die and the optical coupler have sidewalls that align to form outer lateral sidewalls of the photonics IC assembly.

In another example, a photonics integrated circuit (IC) assembly is provided that includes a photonics IC die and an optical coupler. The photonics IC die has four sidewalls, a first surface, a recess formed in the first surface; photonics circuitry, and a waveguide. The waveguide extends from the recess to the photonics circuitry. The optical coupler contacts the first surface of the photonics IC die. The optical coupler has four sidewalls that align with the four sidewalls of the photonics IC die. The optical coupler has a lens that extends into the recess of the photonics IC die.

In still another example, a method for forming a photonics integrated circuit (IC) assembly is provided. The method includes depositing an optically transparent adhesive on (a) a first surface of a first wafer comprising a plurality of photonics integrated circuit (IC) dies, (b) a first surface of a second wafer comprising a plurality of optical couplers, or (c) both the first wafer and the second wafer. The method further includes aligning the photonics IC dies of the first wafer with the plurality of optical couplers of the second wafer; bonding the first wafer to the second wafer with the optically transparent adhesive such that each optical coupler of the plurality of optical couplers is aligned with a corresponding photonics IC die of the plurality of photonics IC dies; and singulating the photonics IC dies. Each singulated photonics IC die bonded to a unique one of the plurality of optical couplers to form a photonics IC assembly.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic top view of one example of a photonics integrated circuit (PIC) wafer with an enlargement of a section thereof.

FIG. 2 is a schematic top view of one example of a coupler wafer with an enlargement of a section thereof.

FIGS. 3A-3E are partial schematic sectional views of a PIC assembly during different stages of fabrication.

FIG. 4 is a flow diagram of one example of a method of fabricating a PIC assembly.

FIG. 5 is a schematic sectional view of one example of a PIC.

FIG. 6 is a schematic sectional view of one example of a coupler.

FIG. 7 is a schematic sectional view of another example of a coupler.

FIG. 8 is a schematic bottom view of the coupler depicted in FIG. 7.

FIG. 9 is a schematic sectional view of another example of a coupler.

FIG. 10 is a schematic bottom view of the coupler depicted in FIG. 9.

FIG. 11 is a side view of one example of PIC assembly.

FIG. 12 is a top view of the PIC assembly of FIG. 11.

FIG. 13 is a side view of one example of PIC assembly.

FIG. 14 is a top view of the PIC assembly of FIG. 13.

FIG. 15 is a side view of one example of PIC assembly.

FIG. 16 is a top view of the PIC assembly of FIG. 15.

To facilitate understanding, identical reference numerals have been used, where possible, to designate identical elements that are common to the figures. It is contemplated that elements of one embodiment may be beneficially incorporated in other embodiments.

### DETAILED DESCRIPTION

Disclosed is a novel optical coupler placement technique that not only enhances throughput but sustains high placement accuracy. An “optical coupler wafer” is first manufactured, followed by bonding the “optical coupler wafer to photonics wafer”. The bonding process accurately pairs an optical coupler with a photonics IC (PIC). Once bonded, the optical coupler/photonics wafer stack is singulated to separate PIC assemblies, where the sidewalls of the optical coupler and the sidewalls of the PIC are aligned so that they define a common outer boundary of the PIC assembly. This technique reduces cost and enhances UPH.

“Optical coupler wafer-on-wafer” bonding approach is applicable for all the OE schemes, including PIC, Compact Universal Photonics Engines (COUPE), and Electronic and Photonic Integrated Circuit (EPIC). With wafer level optics assembly technology, such as available from EV Group, a coupler wafer can be fabricated which matches with PIC’s wafer map. Then, UV adhesive (e.g., UV glue) or other suitable bonding materials/technique is used to bond an optical coupler wafer onto a PIC wafer. The wafer to wafer bonding technique dramatically reduces the time needed to separately bond individual couplers to PIC dies as conventionally practices.

In some examples, improved heat dissipation is realized by utilizing a metal via array in high power area or to create a through coupler wafer cavity for heat sink to attach on metal vias or silicon die.

With the above approach, UPH can be significantly enhanced with high accuracy since only a single UV exposure event is needed to bond a plurality of couplers and good placement accuracy is maintained by leveraging existing wafer-on- wafer stacking technology.

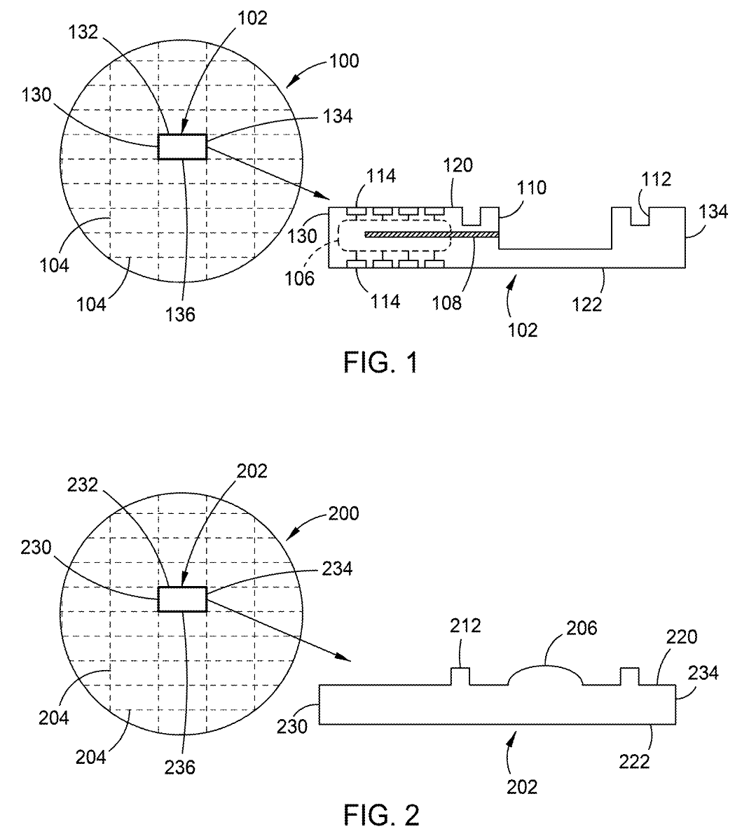

As discussed above, optical coupler bonding process is performed at a wafer-level that enables high-volume-manufacturing (HVM) by leveraging “wafer-on-wafer” process. Wafer-level-optics technology is used to fabricate an optics coupler wafer, which has the same wafer map as PIC wafer, shown as FIGS. 1 and 2.

FIGS. 1 and 2 depict plan views of a PIC wafer 100 and a coupler wafer 200 illustrated for comparison. The PIC wafer 100 has a first surface 120 and a bottom surface 122. The top and bottom surfaces 120, 120 face away from each other. The PIC wafer 100 includes a plurality of photonics integrated circuit dies (PIC dies) 102 separated by scribe lanes 104. The PIC dies 102 are later singulated from the PIC wafer 100 by cutting the PIC wafer 100 along the scribe lanes 104, for example, with a wire saw. After singulation, the first and second surfaces 120, 122 of the PIC wafer 100 become the first and second surfaces 120, 122 of each singulated PIC die 102.

The PIC die 102, as bounded by the scribe lanes 104, has four sidewalls 130, 132, 134, 136 that connect the first and second surfaces 120, 122. The sidewalls 130, 132 face away from each other, while the sidewalls 134, 136 also face away from each other. In one example, the sidewalls 130, 132, 134, 136 form a rectangular shape.

Similarly, the coupler wafer 200 has a first surface 220 and a bottom surface 222. The top and bottom surfaces 220, 220 face away from each other. The coupler wafer 200 is generally fabricated from suitable for optical coupling with the PIC die 102. The coupler wafer 200 may be fabricated from UV fused silica, gradient index glass (GRIN), Lanthanum dense flint glass, and other suitable polymers, epoxies, and glasses.

The coupler wafer 200 includes a plurality of couplers 202 separated by scribe lanes 204. The couplers 202 are later singulated from the coupler wafer 200 by cutting the coupler wafer 200 along the scribe lanes 204, for example, with a wire saw. After singulation, first and second surfaces 220, 222 of the coupler wafer 200 become the first and second surfaces 220, 222 of each singulated coupler 202. The position of the scribe lanes 104 of the PIC wafer 100 are generally correspond and are geometrically aligned with the scribe lanes 204 of the coupler wafer 200 such that after singulation, the size and shape, i.e., foot print, of the PIC die 102 is the same as the foot print of the coupler 202.

The couplers 202, as bounded by the scribe lanes 204, has four sidewalls 130, 232, 234, 236 that connect the first and second surfaces 220, 222. The sidewalls 230, 232 face away from each other, while the sidewalls 234, 236 also face away from each other. In one example, the sidewalls 230, 232, 234, 236 form a rectangular shape.

Referring back to FIG. 1, the PIC die 102 includes photonics circuitry 106 coupled to a waveguide 108. The photonics circuitry 106 may include one or more lasers, optical amplifiers, modulators, filters, splitters and resonators. The photonics circuitry 106 is coupled to the waveguide 108 that provides routing for optical signals into and out of the photonics circuitry 106. The photonics circuitry 106 is also coupled to contact pads 114 formed on at least one of the top and bottom surfaces 120, 122 of the PIC wafer 100.

Each PIC dies includes a recess 110 formed in the first surface 120 of the PIC wafer 100 for receiving a lens 206 of the coupler 202. Adjacent the recess 110, one or more alignment structures 112 are formed in the first surface 120 of the PIC wafer 100. In the example, depicted in FIG. 1, the alignment structures 112 are in the form of an aperture that is configured to receive a mating alignment structure 212, shown as a post in FIG. 2, extending from the first surface 220 of the coupler wafer 200. It is contemplated that other mating geometry may be utilized for the alignment structures 112, 212, and that the alignment structures 112 may extend from the PIC wafer 100 and the complimentary matting alignment structures 212 may be recessed into the first surface 220 of the coupler 202.

As briefly stated above and now referring primarily to FIG. 2, the coupler wafer 200 includes a plurality of couplers 202 separated by the scribe lanes 204. Each coupler 202 includes a lens 206 projecting above the first surface 220 of the coupler wafer 200. In the example depicted in FIG. 2, the alignment structures 212 also project above the first surface 220 of the coupler wafer 200. The alignment structures 212 generally are disposed adjacent to the lens 206. For example, the coupler 202 may include two alignment structures 212, one disposed on opposite sides of the lens 206. In another example, the coupler 202 may include three, four or more alignment structures 212 that are positioned around the lens 206, for example on a common radius relative to a centerline of the lens 206.

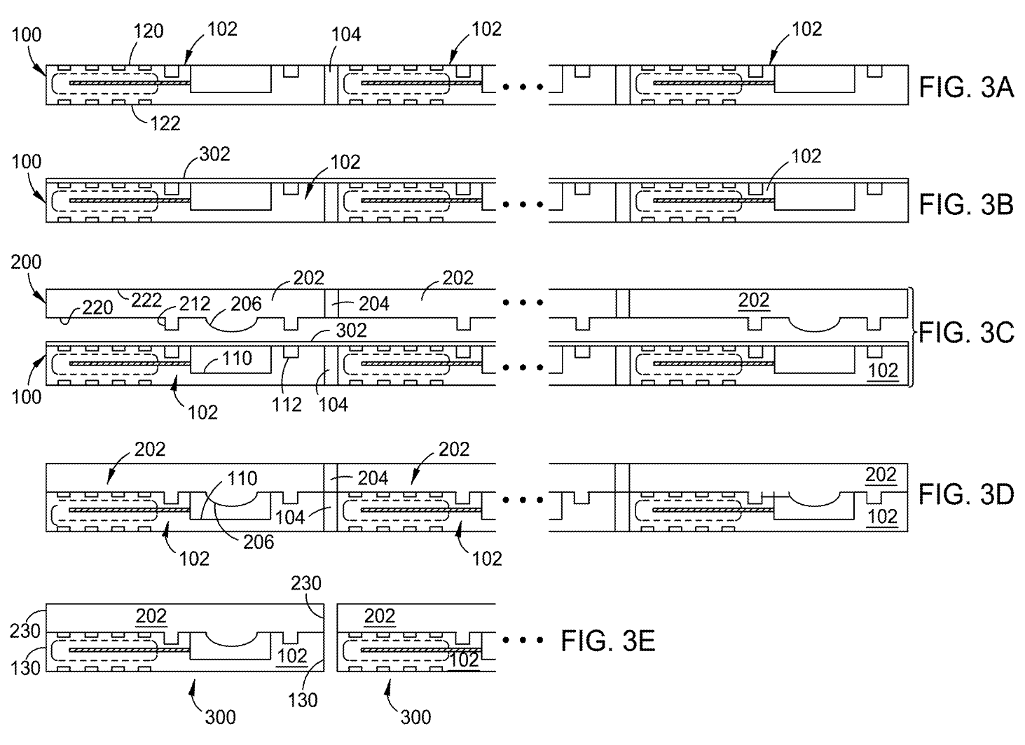

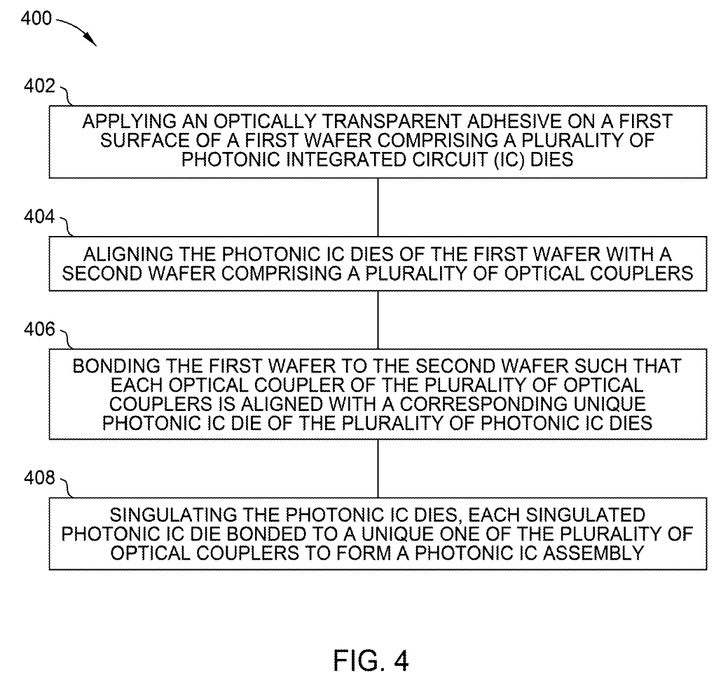

FIGS. 3A-3E are partial schematic sectional views of a PIC assembly during different stages of fabrication. FIG. 4 is a flow diagram of one example of a method 400 of fabricating a photonics integrated circuit (IC) assembly. Referring to FIGS. 3A-3E and FIG. 4, the method 400 begins at operation 402 by depositing an optically transparent adhesive 302 on a first surface 120 of a first wafer (e.g., the PIC wafer 100) comprising a plurality of photonics integrated circuit (IC) dies (e.g., PIC dies 102), as illustrated by FIGS. 3A-3B.

The optically transparent adhesive 302 may be UV or other suitable adhesive is dispensed on one or both of PIC wafer 100 and the coupler wafer 200. The adhesive 302 may be dispensed in a number of manners, such as but not limited to dispensing, printing, and jetting, among other techniques. As an alternative to UV adhesive, other bonding materials or techniques may also be used, such as dielectric or polymer for fusion bonding. In one example, the optically transparent adhesive 302 covers the entire surface 120 and/or 220.

At operation 404, the photonics IC dies of the first wafer 100 are aligned with a second wafer 200 comprising a plurality of optical couplers 202. When aligning the wafers 100, 200, the first surface 120 of the first wafer 100 is facing the first surface 220 of the second wafer 200 and the alignment structures 112, 212 are aligned in a manner that allows the first surface 120 of the first wafer 100 to mate with the first surface 220 of the second wafer 200 as the wafers 100, 200 are brought into contact with each other. The mating engagement of the alignment structures 112, 212 prevents the PIC die 102 and coupler 202 from laterally moving relative to each other. As the first surface 120 of the first wafer 100 contacts the first surface 220 of the second wafer 200, the lens 206 of the second wafer 200 extend into the recess 110 of the first wafer 100.

Alignment between the PIC wafer 100 and optical coupler wafer 200 may be performed using passive alignment. The X and Y positions of the wafers 100, 200 can be controlled using fiducial mark alignment between PIC wafer and coupler wafer, which can have an accuracy within 0.5 um. Spacing between the PIC wafer 100 and optical coupler wafer 200 in the Z-direction may be controlled by various ways, such as fabricating a Z-direction stop (such as a stand-off) on PIC wafer 100 or controlling wafer to wafer bond force, among other techniques. In one example, the alignment structures 112, 212 may bottom out to set the relative spacing in the Z-direction between the PIC and coupler wafers 100, 200.

Once alignment and placement are complete, the first (PIC) wafer 100 is bonded at operation 406 to the second (coupler) wafer 200 such that each optical coupler 202 of the plurality of optical couplers 200 formed on the coupler wafer 200 is aligned with a corresponding photonics IC die 102 of the plurality of photonics IC dies 102 formed on the PIC wafer 100, with the alignment structures 112, 212 mating and the lens 206 disposed in the recess 110, as illustrated in FIG. 3D. In one example, the adhesive 302 is a UV adhesive and is cured by exposure to UV light. The transparent optical coupler wafer 200 enables the entire wafer 200 to be bonded in a single UV exposure instead of snap curing one coupler at a time as done in conventional processes that bond the coupler to the PIC after singulation. Advantageously, bonding the couplers 202 to the PIC dies 102 prior to singulation significantly enhances fabrication throughput, which correspondingly reduces the cost to manufacture. In one example, the optically transparent adhesive 302 covers the entire surface 120 and/or 220, providing additional warpage resistance.

At operation 408, photonics IC assemblies 300 are formed by dicing the stacked and bonded wafers 100, 200, thus singulating stacked pairs of photonics IC dies 102 and couplers 202, as shown in FIG. 3E. Each singulated photonics IC die 102 bonded to a unique one of the plurality of optical couplers 202 to form unique photonics IC assemblies 300. Stated differently, after PIC and coupler wafers 100, 200 are bonded, the stacked wafers 100, 200 are diced together as a unit to singulated separate PIC assemblies 300, each assembly 300 including at least one coupler and PIC die pair. The PIC wafer 100 can be coupled with an electronic integrated circuit die, compact universal photonics engine or other integrated optical engine. With this approach, the optical engine module may have a flat backside surface, which is very friendly to on-substrate process. Additionally, the balanced structure (i.e., same footprint) can help reduce local warpage.

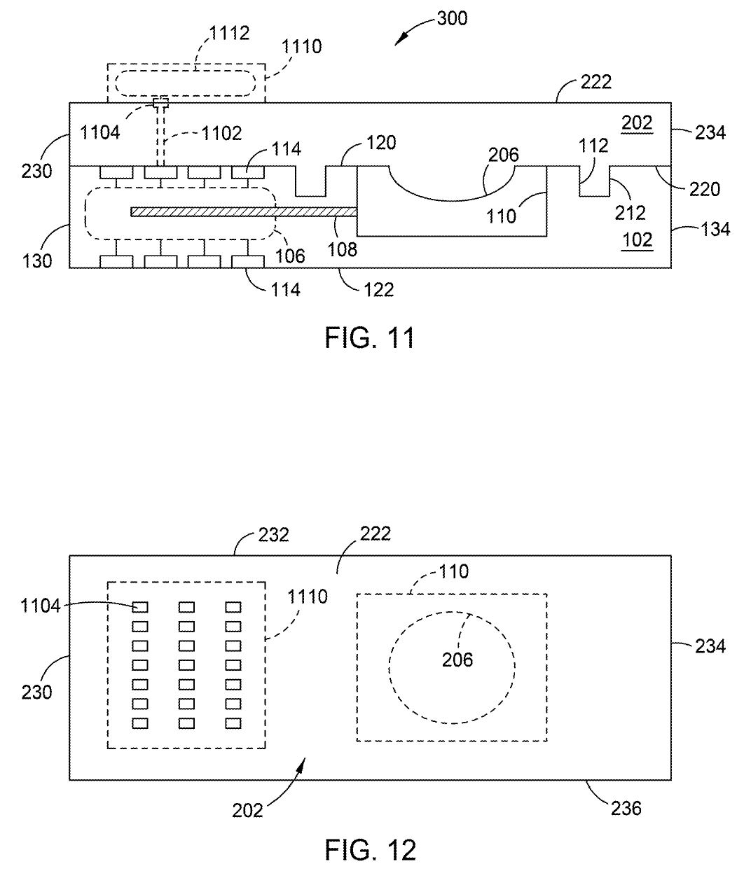

The photonics IC assemblies 300 can be connected with a co-packaged electrical IC (EIC) die as later discussed below. The EIC die may also be integrated into the photonics IC assembly, as further discussed with reference to FIGS. 11-16.

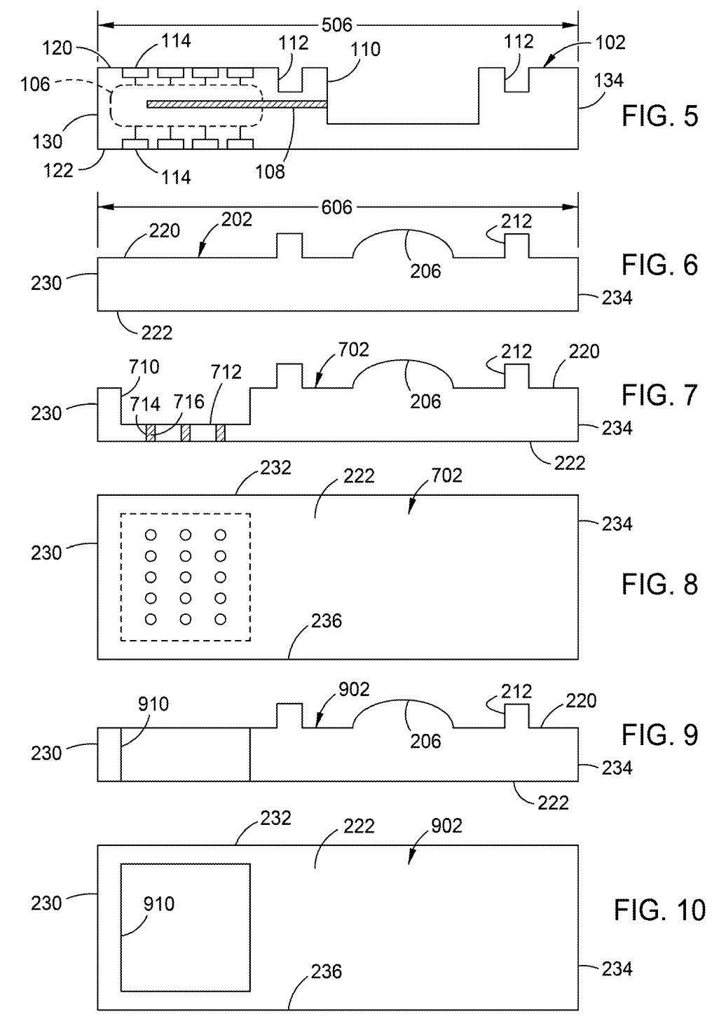

Turning now to FIGS. 5 and 6, a singulated PIC die 102 and a singulated optical coupler 202 are illustrated. The PIC die 102 generally has opposing sidewalls 130, 134 that connect the first and second surfaces 120, 122. A distance 506 is defined between the sidewalls 130, 134. The photonics circuitry 106 is offset closer to one of the sidewalls, for example the sidewall 130. Similarly, the recess 110 is offset toward the other sidewall 134. The recess 110 includes a sidewall at which one end of the waveguide 108 terminates.

The coupler 202 generally has opposing sidewalls 230, 234 that connect the first and second surfaces 220, 222. Such that the lens 206 may be received in the recess 110 when the wafers 100, 200 are stacked, the lens 206 is also offset closer to one of the sidewalls, i.e., the sidewall 234. A distance 606 is defined between the sidewalls 230, 234. As the PIC die 102 and the coupler 202 have the same side and shape, the distances 506 and 606 are the same as the bonded wafers 100, 200 were simultaneously diced along the stacked scribe lanes 104, 204. Although not shown in FIGS. 5 and 6, the front and back sidewalls connecting the sidewalls 130, 134 and 230, 234 are also separated by the same distances. In this manner, the sidewalls comprising the PIC die 102 and the coupler 202 are aligned to form substantially uniform sidewalls on the PIC assembly 300.

FIG. 7 is a schematic sectional view of another example of a coupler 702 that can be formed in the coupler wafer 200 and used to fabricate a PIC assembly (700, later illustrated in FIG. 11). The coupler 702 is substantially the same coupler 202, except wherein the coupler 702 has an electronic integrated circuit (EIC) die receiving cavity 710 formed in the first surface 220 of the coupler 702. The EIC die receiving cavity 710 is generally sized to allow an EIC die mounted to the PIC die 102 to extend into the coupler 202 so that the coupler 202 and PIC die 102 can be disposed flush against each other.

The EIC die receiving cavity 710 has a bottom 712. A plurality of apertures 714 extend between the bottom 712 and the second surface 222 of the PIC die 102. The apertures 714 may be filled or left as an open air passage. In the example depicted in FIGS. 7 and 8, the plurality of apertures 714 are filled with a thermally conductive filler 716. In one example, the thermally conductive filler 716 is a metal, such as copper, aluminum, and the like.

As illustrated in the schematic bottom view of the coupler 702 depicted in FIG. 8, the apertures 714 filled with the thermally conductive filler 716 may be formed in a rows and couples, on concentric bolt circles, randomly, or in another suitable arrangement. The thermally conductive filler 716 has a much faster heat transfer rate than the material comprising the coupler 702. Thus, the thermally conductive filler 716 promotes the transfer of heat generated by the EIC die out of the EIC die receiving cavity 710, thus enhancing the performance, reliability, and service life of the EIC die.

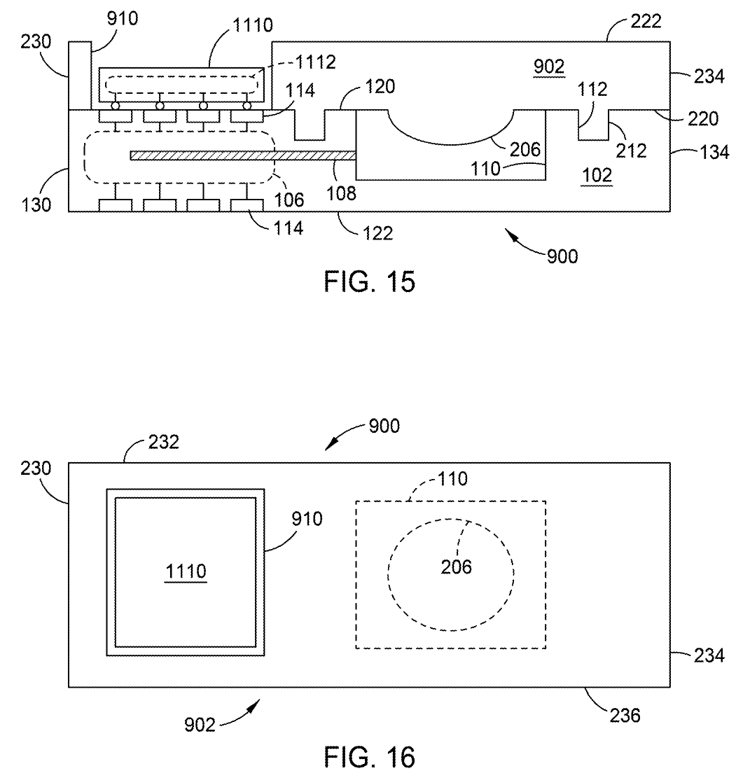

FIGS. 9 and 10 are schematic sectional and bottom views of another example of a coupler 902 that can be formed in the coupler wafer 200 and used to fabricate a PIC assembly (900 later illustrated in FIG. 15). The coupler 902 is substantially the same as the couplers 202, 702 described above, except wherein the coupler 902 has an electronic integrated circuit (EIC) die receiving aperture 910 formed in the first surface 220 of the coupler 902. The EIC die receiving aperture 910 is generally sized to allow an EIC die mounted to the PIC die 102 to extend into the coupler 902 so that the coupler 902 and PIC die 102 can be disposed flush against each other.

The EIC die receiving aperture 910 extends between the first and second surfaces 220, 222 of the coupler 902. The EIC die receiving aperture 910 allows heat from the EIC die to radiate and conduct out from the top of the EIC die without being trapped by or having to pass through the material comprising the coupler 902. Thus, the EIC die receiving aperture 910 allows the transfer of heat generated by the EIC die to be efficiently removed, thus enhancing the performance, reliability, and service life of the EIC die.

FIGS. 11-16 are paired side and top views of various examples of PIC assemblies. Referring first to FIGS. 11 and 12, a schematic side view and a top views of a PIC assembly 300 is illustrated after singulation from the bonded PIC and coupler wafers 100, 200. The PIC assembly 300 may be fabricated in accordance with the method 400 described above, of other suitable technique. The PIC assembly 300 generally includes a coupler 202 mounted to a PIC die 102. The coupler 202 and the PIC die 102 of the PIC assembly 700 may be secured together using an optical adhesive, fusion bonding, or other technique. The lens 206 of the coupler 202 extends into the recess 110 of the PIC die 102 to enable light passing through the coupler 202 and exiting the lens 206 to enter the waveguide 108 and be transmitted to the photonics circuitry 106 of the PIC die 102.

The photonics circuitry 106 of the PIC die 102 terminates at contact pads 114 formed on at least the second surface 122 of the PIC die 102. The contact pads 114 formed on the second surface 122 of the PIC die 102 are generally used to mechanically and electrically connect the PIC die 102 to an interposer, package substrate, bridge die, or other IC die view solder interconnects (such as micro bumps) or hybrid bonding. In one example, an EIC die that is located remote from the PIC die 102 but within the same chip package is coupled to the photonics circuitry 106 of the PIC die 102 through the contact pads 114 formed on the second surface 122 of the PIC die 102.

In another example, the photonics circuitry 106 of the PIC die 102 also terminates at contact pads 114 formed on the first surface 120 of the PIC die 102. The contact pads 114 formed on the first surface 120 of the PIC die 102 are generally used to mechanically and electrically connect the PIC die 102 to transmission vias 1102 formed coupler 202. The transmission vias 1102 terminate at contact pads 1104 formed on the second surface 222 of the coupler 202. An EIC die 1110 shown in phantom in FIGS. 11 and 12 are electrically and mechanically mounted to the contact pads 1104 formed on the second surface 222 of the coupler 202. In this manner, functional circuitry 1112 of the EIC die 1110 is coupled to the photonics circuitry 106 of the PIC die 102. The functional circuitry 1112 of the EIC die 1110 may also communicate with other electronic devices through the contact pads 114 formed on the second surface 122 of the PIC die 102. Among other electronic devices comprising the functional circuitry 1112 of the EIC die 1110, the EIC die 1110 also include trans-impedance amplifiers and drivers for amplification of the signals outputted from the photonics circuitry 108 of the PIC die 102.

As illustrated in FIGS. 11 and 12, the sidewalls 130, 134 of the PIC die 102 have the same length and geometry as the 230, 234 of the coupler 202. Similarly, the sidewalls 1202, 1204 of the PIC die 102 that are perpendicular to and extend between the sidewalls 130, 134 have the same length and geometry as the sidewalls 802, 804 of the coupler 202 that are perpendicular to and extend between the sidewalls 230, 234 of the coupler 202. Thus, the area and geometry the outer extents of both the PIC die 102 and coupler 202 are the same such that the PIC assembly 300 has greater resistance to warpage.

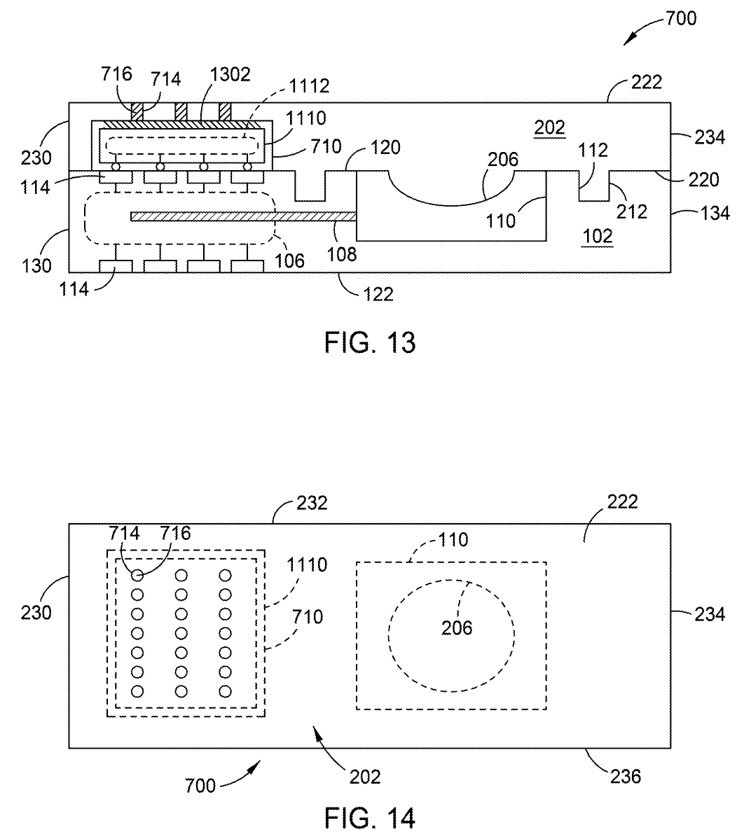

FIGS. 13 and 14 are schematic side view and a top views of a PIC assembly 700 is illustrated after singulation from the bonded PIC and coupler wafers 100, 200. The PIC assembly 700 may be fabricated in accordance with the method 400 described above, of other suitable technique. The PIC assembly 700 generally includes a coupler 702 mounted to a PIC die 102. The coupler 702 and the PIC die 102 of the PIC assembly 700 may be secured together using an optical adhesive, fusion bonding, or other technique. The lens 206 of the coupler 702 extends into the recess 110 of the PIC die 102 to enable light passing through the coupler 702 and exiting the lens 206 to enter the waveguide 108 and be transmitted to the photonics circuitry 106 of the PIC die 102.

The photonics circuitry 106 of the PIC die 102 terminates at contact pads 114 formed on the first and second surfaces 120, 122 of the PIC die 102. The contact pads 114 formed on the second surface 122 of the PIC die 102 are generally used to mechanically and electrically connect the PIC die 102 to an interposer, package substrate, bridge die, or other IC die view solder interconnects (such as micro bumps) or hybrid bonding. The contact pads 114 formed on the first surface 120 of the PIC die 102 are generally used to mechanically and electrically connect the PIC die 102 to an EIC die 1110 residing in the EIC die receiving cavity 710 of the coupler 702. Thermal interface material 1302 may be disposed between the EIC die 1110 and the bottom surface of the EIC die receiving cavity 710 of the coupler 702 to promote heat transfer to from the EIC die 1110 and the thermally conductive filler 716 disposed in the plurality of apertures 714 formed in the bottom 712 of the coupler 702. The EIC die 1110 is mounted to the PIC die 102 prior to stacking with the coupler wafer 200 and singulation. In this manner, functional circuitry 1112 of the EIC die 1110 is coupled very close to the photonics circuitry 106 of the PIC die 102 without intervening circuit structures that may reduce response times or introduce cross-talk. The functional circuitry 1112 of the EIC die 1110 may also communicate with other electronic devices through the contact pads 114 formed on the second surface 122 of the PIC die 102.

FIGS. 15 and 16 are schematic side view and a top views of a PIC assembly 900 is illustrated after singulation from the bonded PIC and coupler wafers 100, 200. The PIC assembly 900 may be fabricated in accordance with the method 400 described above, of other suitable technique. The PIC assembly 900 generally includes a coupler 902 mounted to a PIC die 102. The coupler 902 and the PIC die 102 of the PIC assembly 900 may be secured together using an optical adhesive, fusion bonding, or other technique. The lens 206 of the coupler 902 extends into the recess 110 of the PIC die 102 to enable light passing through the coupler 902 and exiting the lens 206 to enter the waveguide 108 and be transmitted to the photonics circuitry 106 of the PIC die 102.

The photonics circuitry 106 of the PIC die 102 terminates at contact pads 114 formed on the first and second surfaces 120, 122 of the PIC die 102. The contact pads 114 formed on the second surface 122 of the PIC die 102 are generally used to mechanically and electrically connect the PIC die 102 to an interposer, package substrate, bridge die, or other IC die view solder interconnects (such as micro bumps) or hybrid bonding. The contact pads 114 formed on the first surface 120 of the PIC die 102 are generally used to mechanically and electrically connect the PIC die 102 to an EIC die 1110 extending through the EIC receiving aperture 910 of the coupler 902. As the top of the EIC die 1110 that faces away from the PIC die 102 is open through the coupler 902, heat from the EIC die 1110 is readily dissipated without having to pass through the material of the coupler 902. The EIC die 1110 may be mounted to the PIC die 102 after or prior to stacking with the coupler wafer 200 and singulation. In this manner, functional circuitry 1112 of the EIC die 1110 is coupled very close to the photonics circuitry 106 of the PIC die 102 without intervening circuit structures that may reduce response times or introduce cross-talk. The functional circuitry 1112 of the EIC die 1110 may also communicate with other electronic devices through the contact pads 114 formed on the second surface 122 of the PIC die 102.

During the operation, the EIC die 1110 generates heat. To enhance thermal management and to enable EIC/PIC integration (by hybrid bond, solder joint or others), different optical coupler design can be achieved using the same concept, such as creating a through wafer cavity for EIC or adding metal filled vias for heat dissipation.

As coupler’s thermal conductivity is not high, adding metal filled vias enhances thermal dissipation. The coupler may have an EIC receiving cavity that allows EIC die to be efficiently integrated with the PIC die. Once coupler wafer is complete, holes can be made in in high power location using a laser drill (or other) process to create a through coupler via. The coupler via is filled with a conductive material, such as a metal (for example copper). Coupler thermal conductivity can be significantly enhanced as metal’s thermal conductivity is much better than glass and polymer. As a result, heat from the EIC die can be transferred to heat sink mounted on the second side of the coupler through the coupler’s metal filled vias.

In another example, a larger rectangular (larger than EIC die) through coupler cavity (e.g., aperture) is provided to accept the EIC die. In this approach, EIC dies silicon backside can be exposed and directly contacted to a heat sink (optionally through a thermal interface material (TIM).

Some advantages of the above technique include significantly enhanced throughput while maintaining good placement accuracy and lowering the cost of manufacturing. From structure and reliability point of view, a balanced structure is always better than un-balanced one. Existing solutions make structure unbalanced as the coupler only partially covers the PIC, which may lead to high local warpage and high stress. With balanced structure, improved reliability and performance (e.g. thermal cycles) and larger process window (for on-substrate process) are achieved.

Some examples provide enhanced thermal management. Moreover, the disclosed technology is applicable for different OE schemes, including PIC, EPIC and COUPE.

The above described technology may be expressed by one or more of the following non-limiting examples.

Example 1. A photonics integrated circuit (IC) assembly including: a photonics IC die; and an optical coupler bonded to the photonics IC die, the photonics IC die and the optical coupler having sidewalls aligned to form outer lateral sidewalls of the photonics IC assembly.

Example 2. The photonics IC assembly of Example 1 further including: an electronic integrated circuit (EIC) die mounted on the photonics IC die and exposed through an aperture formed through the optical coupler.

Example 3. The photonics IC assembly of Example 1 further including: an electronic integrated circuit (EIC) die mounted on a surface of the photonics IC die that faces the optical coupler.

Example 4. The photonics IC assembly of Example 3, wherein the optical coupler includes a recess that receives the EIC die.

Example 5. The photonics IC assembly of Example 4, wherein the recess further includes: a plurality of apertures extending through the optical coupler from a bottom surface of the recess to a side of optical coupler that faces away from the PIC die.

Example 6. The photonics IC assembly of Example 5 further including: thermally conductive material filling the plurality of apertures.

Example 7. The photonics IC assembly of Example 6 further including thermal interface material contacting the bottom surface of the recess and the EIC die.

Example 8. The photonics IC assembly of Example 1 further including: a lens extending from a first surface of the optical coupler into a recess formed in a first surface of the photonics IC die; one or more coupler alignment structures formed on or in the first surface of the optical coupler; and one or more PIC alignment formed on or in surface of the PIC die disposed against the first surface of the optical coupler, the one or more PIC alignment mating with the one or more coupler alignment structures in a manner that prevents lateral movement of the PIC die and the optical coupler.

Example 9. The photonics IC assembly of Example 1 further including: an optical adhesive securing the photonics IC die to the optical coupler, the optical adhesive extending between opposite sidewalls of the optical coupler.

Example 10. The photonics IC assembly of Example 1 further including: an electronic integrated circuit (EIC) die mounted on a surface of the optical coupler that faces away from the photonics IC die, functional circuitry of the EIC die coupled to photonics circuitry of the PIC die through the optical coupler.

Example 11. A photonics integrated circuit (IC) assembly including: a photonics IC die having four sidewalls, a first surface, a recess formed in the first surface; photonics circuitry, and a waveguide, the waveguide extending from the recess to the photonics circuitry; and an optical coupler contacting the first surface of the photonics IC die, the optical coupler having four sidewalls that align with the four sidewalls of the photonics IC die, the optical coupler having a lens that extends into the recess of the photonics IC die.

Example 12. The photonics IC assembly of Example 11 further including: an electronic integrated circuit (EIC) die mounted on the photonics IC die.

Example 13. The photonics IC assembly of Example 12, wherein the optical coupler includes a recess that receives the EIC die.

Example 14. The photonics IC assembly of Example 13, wherein the recess further includes: a plurality of apertures extending through the optical coupler from a bottom surface of the recess to a side of optical coupler that faces away from the PIC die; and thermally conductive material filling the plurality of apertures.

Example 15. The photonics IC assembly of Example 12, wherein the EIC die is exposed through an aperture formed through the optical coupler.

Example 16. A method for forming a photonics integrated circuit (IC) assembly, the method including: depositing an optically transparent adhesive on (a) a first surface of a first wafer including a plurality of photonics integrated circuit (IC) dies, (b) a first surface of a second wafer including a plurality of optical couplers, or (c) both the first wafer and the second wafer; aligning the photonics IC dies of the first wafer with the plurality of optical couplers of the second wafer; bonding the first wafer to the second wafer with the optically transparent adhesive such that each optical coupler of the plurality of optical couplers is aligned with a corresponding photonics IC die of the plurality of photonics IC dies; and singulating the photonics IC dies, each singulated photonics IC die bonded to a unique one of the plurality of optical couplers to form a photonics IC assembly.

Example 17. The method of Example 16, further including: exposing a top surface of an electronic integrated circuits (EIC) mounted on the first wafer through an aperture in the second wafer.

Example 18. The method of Example 16, further including: aligning one or more conductive material filled apertures disposed in the second wafer with a top surface of an electronic integrated circuits (EIC) mounted on the first wafer.

Example 19. The method of Example 16, further including: mounting an electronic integrated circuits (EIC) on the first wafer prior to bonding the first wafer to the second wafer.

Example 20. The method of Example 16, further including: mounting an electronic integrated circuits (EIC) on the second wafer.

While the foregoing is directed to embodiments of the present invention, other and further embodiments of the invention may be devised without departing from the basic scope thereof, and the scope thereof is determined by the claims that follow.

What is claimed is:

1. A photonics integrated circuit (IC) assembly comprising:
a photonics IC die; and
an optical coupler bonded to the photonics IC die, the photonics IC die and the optical coupler having sidewalls aligned to form outer lateral sidewalls of the photonics IC assembly.

2. The photonics IC assembly of claim 1 further comprising:
an electronic integrated circuit (EIC) die mounted on the photonics IC die and exposed through an aperture formed through the optical coupler.

3. The photonics IC assembly of claim 1 further comprising:
an electronic integrated circuit (EIC) die mounted on a surface of the photonics IC die that faces the optical coupler.

4. The photonics IC assembly of claim 3, wherein the optical coupler comprises a recess that receives the EIC die.

5. The photonics IC assembly of claim 4, wherein the recess further comprises:
a plurality of apertures extending through the optical coupler from a bottom surface of the recess to a side of optical coupler that faces away from the photonics IC die.

6. The photonics IC assembly of claim 5 further comprising:
thermally conductive material filling the plurality of apertures.

7. The photonics IC assembly of claim 6 further comprising:
thermal interface material contacting the bottom surface of the recess and the EIC die.

8. The photonics IC assembly of claim 1 further comprising:
a lens extending from a first surface of the optical coupler into a recess formed in a first surface of the photonics IC die;
one or more coupler alignment structures formed on or in the first surface of the optical coupler; and
one or more PIC alignment formed on or in surface of the PIC die disposed against the first surface of the optical coupler, the one or more PIC alignment mating with the one or more coupler alignment structures in a manner that prevents lateral movement of the PIC die and the optical coupler.

9. The photonics IC assembly of claim 1 further comprising:
an optical adhesive securing the photonics IC die to the optical coupler, the optical adhesive extending between opposite sidewalls of the optical coupler.

10. The photonics IC assembly of claim 1 further comprising:
an electronic integrated circuit (EIC) die mounted on a surface of the optical coupler that faces away from the photonics IC die, functional circuitry of the EIC die coupled to photonics circuitry of the photonics IC die through the optical coupler.

11. A photonics integrated circuit (IC) assembly comprising:
a photonics IC die having four sidewalls, a first surface, a recess formed in the first surface; photonics circuitry, and a waveguide, the waveguide extending from the recess to the photonics circuitry; and
an optical coupler contacting the first surface of the photonics IC die, the optical coupler having four sidewalls that align with the four sidewalls of the photonics IC die, the optical coupler having a lens that extends into the recess of the photonics IC die.

12. The photonics IC assembly of claim 11 further comprising:
an electronic integrated circuit (EIC) die mounted on the photonics IC die.

13. The photonics IC assembly of claim 12, wherein the optical coupler comprises a recess that receives the EIC die.

14. The photonics IC assembly of claim 13, wherein the recess further comprises:
a plurality of apertures extending through the optical coupler from a bottom surface of the recess to a side of the optical coupler that faces away from the photonics IC die; and
thermally conductive material filling the plurality of apertures.

15. The photonics IC assembly of claim 12, wherein the EIC die is exposed through an aperture formed through the optical coupler.

16. A method for forming a photonics integrated circuit (IC) assembly, the method comprising:
depositing an optically transparent adhesive on (a) a first surface of a first wafer comprising a plurality of photonics integrated circuit (IC) dies, (b) a first surface of a second wafer comprising a plurality of optical couplers, or (c) both the first wafer and the second wafer;
aligning the photonics IC dies of the first wafer with the plurality of optical couplers of the second wafer;
bonding the first wafer to the second wafer with the optically transparent adhesive such that each optical coupler of the plurality of optical couplers is aligned with a corresponding photonics IC die of the plurality of photonics IC dies; and
singulating the photonics IC dies, each singulated photonics IC die bonded to a unique one of the plurality of optical couplers to form a photonics IC assembly.

17. The method of claim 16, further comprising:
exposing a top surface of an electronic integrated circuits (EIC) mounted on the first wafer through an aperture in the second wafer.

18. The method of claim 16, further comprising:
aligning one or more conductive material filled apertures disposed in the second wafer with a top surface of an electronic integrated circuits (EIC) mounted on the first wafer.

19. The method of claim 16, further comprising:
mounting an electronic integrated circuits (EIC) on the first wafer prior to bonding the first wafer to the second wafer.

20. The method of claim 16, further comprising:
mounting an electronic integrated circuits (EIC) on the second wafer.
